(19) United States
(12) Patent Application Publication
(10) Pub. No.: US 2006/0031096 A1
(43) Pub. Date: Feb. 9, 2006

(54) Clinical documentation tool with protected and revisable text expansion

(76) Inventors: Mark Duane Buttner, Middleton, WI (US); Murali Krishna Ramanathan, West Lafayette, IN (US); Rajeev Kumar Gangwar, Madison, WI (US); Tina Marie Buttner, Middleton, WI (US)

Correspondence Address: QUARLES & BRADY LLP, 411 E. WISCONSIN AVENUE, SUITE 2040, MILWAUKEE, WI, 53202-4497, US

(21) Appl. No.: 10/951,947

(22) Filed: Sep. 28, 2004

Related U.S. Application Data
(60) Provisional application No. 60/598,686, filed on Aug. 4, 2004.

(51) Int. Cl. G06Q 10/00

(52) U.S. Cl. 705/2

(57) ABSTRACT

Automatic text generation is marked in a text document to allow later re-invocation of automatic text generation to revise the expanded text and to ensure integrity in capture of machine interpretable data generated during automatic text generation.

### CROSS-REFERENCE TO RELATED APPLICATIONS

This application claims the benefit of provisional patent application No. 60/598,686, filed Aug. 4, 2004, entitled “Medical Report Tool with Revisable Text Expansion” incorporated herein by reference.

### STATEMENT REGARDING FEDERALLY SPONSORED RESEARCH OR DEVELOPMENT

### BACKGROUND OF THE INVENTION

The present invention relates generally to computer programs for text entry and in particular to a program allowing protection and revision of text expansions generated by software from simple user commands.

Physicians, in maintaining patient records, ordinarily prepare summaries of patient visits or treatments. Although these summaries may be dictated by the physician for later transcription, often the physician types these summaries directly into a computer system in order to avoid transcription errors, delay and the additional cost of transcription services. In these circumstances, it is desirable to simplify the process of typing the summaries as much as possible.

One method of rapidly creating patient visit summaries, often termed “checkbox charting,” allows the physician to simply check, on a computer screen, checkboxes associated with particular report information. A computer program maps checkboxes to text strings to create the report. This method speeds report generation and has the added benefit of allowing the information of the report to be captured in a machine-readable format (for example, searchable diagnosis codes) at the time the text is created.

“Checkbox charting” has a number of disadvantages. The checkbox form is generated by a program and relatively inflexible if changes in the form are required. Checkboxes may not adequately record complex observations, unusual diagnoses or may not be compatible with a physician's particular style or preference.

For these reasons, report generation systems that allow direct text entry and editing, as with a word processor, are often preferred. Generating reports using such direct text entry can be simplified by automatic text generation techniques such as text expansion. In one technique described in U.S. Pat. No. 5,781,891, short abbreviations preceded by a special character prefix automatically cause the abbreviation to be replaced by a longer, previously stored phrase corresponding to that abbreviation.

More sophisticated text expansion may use embedded links within a text template that are replaced by data from a database, such as an electronic medical record, to automatically import not simply a static phrase but data about a patient or condition that may vary over time or in different contexts. For example, the assignee of the present inventions offers a commercial program in which a character string link “.id”, when entered into a text field, is automatically replaced with a sentence describing the name, age and sex of the particular patient for whom the report is being generated. Alternatively, a link may invoke a set of pick lists, individually or in nested format, so as to allow selection among a variety of text phrases that will be used to replace the link.

The result of direct text entry and editing, with or without automatic text generation, is a flexible text document that can be readily reused and edited, for example, for later reports regarding the same patient. Because the links in the original template are replaced with expanded text, the resulting text document normally loses the simple text expansion capabilities and must be edited using only normal text-editing techniques.

The versatility of a text document in capturing patient notes is offset by the difficulty of extracting machine-interpretable data from such text. While programs exist which attempt to “mine” text data for information, such programs are imperfect and prone to error.

### BRIEF SUMMARY OF THE INVENTION

The present invention provides a direct text entry and editing system allowing software text expansion, not only in an original template document but also in later versions of the resultant text document or portions thereof. This is accomplished by marking text expansions as not directly editable. Marking prevents unrecorded alteration of the substance of the expanded text, allowing the act of text expansion to be used to generate machine readable data about the text. Further, the marking allows revision of the expanded text by invoking the same text expansion procedure that originally generated the expanded text.

Specifically then, the present invention provides a program for drafting clinical documentation, executable on a computer, to display to a user a text-editing box allowing entry and editing of the text within a text field of the text-editing box. The program, like a standard text editor, allows the user to replace text with different text in a standard edition operation. The program also accepts links into the text field that allow selection among different text to be imported from an outside source into the text field by user selection commands so as to provide “expanded text”. Upon receiving a first user selection command, the program imports selected text from the outside source into the text field and marks the expanded text to allow later selection of different text from the outside source by a second user selection command.

Thus it is one object of at least one embodiment of the invention to allow software expanded text to be later “re-expanded” so that copies of a text report can be modified as easily as the original.

The expanded text may be marked with characters embedded in the text field.

Thus it is another object of at least one embodiment of the invention to provide a method of marking expanded text that can be carried within the text document.

The characters may cause a highlighting of the expanded text.

It is thus another object of at least one embodiment of the invention to provide an indication to the user that the text is not directly editable without re-expansion.

The expanded text may come from a database such as an electronic medical record.

Thus it is another object of at least one embodiment of the invention to provide a method of quickly creating or editing a medical report to contain previously acquired medical data about a patient.

The selection command may include the step of selecting a text string associated with a link.

Thus it is yet another object of at least one embodiment of the invention to provide for user control over the importation text.

Upon receiving the selection command, the program may present a menu from which text may be selected.

It is thus another object of at least one embodiment of the invention to provide a rapid menu or tree-type selection process for text that can be invoked multiple times in the editing history of a document.

The menu may allow simultaneous selection of multiple text items to be imported in sequence.

It is thus another object of at least one embodiment of the invention to allow re-editing of text that is only part of an expanded text string.

A database may be updated upon each importation to provide a machine-interpretable record of the expanded text.

Thus, it is one object of at least one embodiment of the invention to provide integrity in automatically entered text so that its generation may be relied on to prepare a machine-readable version of the text content using standard terms and discrete values for reporting and the like.

The database may be a patient electronic medical record or other data repository.

It is thus another object of at least one embodiment of the invention to provide automatic updating of an electronic medical record accessible by many health care professionals to disseminate information that would normally be locked in the patient visit summary.

The program may provide for a transfer of expanded text from a first user to a second user. The second user may select the expanded text to cause a re-expansion of the text from a local source.

Thus it is another object of at least one embodiment of the invention to allow sharing of templates providing text expansion among users.

These particular objects and advantages may apply to only some embodiments falling within the claims and thus do not define the scope of the invention.

### BRIEF DESCRIPTION OF THE DRAWINGS

FIG. 1 is a block diagram of the program of the present invention showing the steps of automatic text generation and the marking of the expanded text;

FIG. 2 is a simplified block diagram of the two programs similar to those of FIG. 1 showing the importing of a text document between applications and the establishment of context for subsequent revision of expanded text;

FIG. 3 is a flow chart executed by the program of the present invention when automatically generating text per the diagram of FIG. 1; and

FIG. 4 is a flow chart showing steps taken by a subsequent program enabled to accept the marked text showing the results of a user attempt to edit marked text.

### DETAILED DESCRIPTION OF THE PREFERRED EMBODIMENT

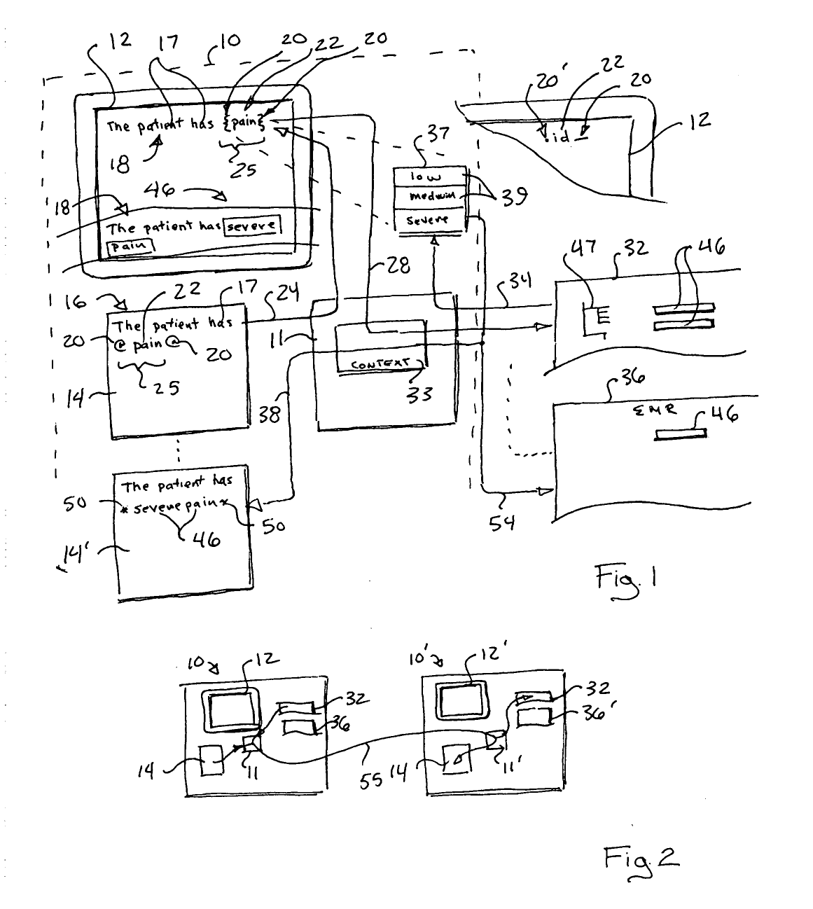

Referring now to FIG. 1, a clinical documentation program 10, such as may run on a standard computer or the like, may provide a smart text object 11 instantiated with context information 33 as part of the documentation program 10. The context information 33 may, for example, provide an identification of a patient for whom the medical report is being generated as well as institutional data.

Upon instantiation, the smart text object generates a text-edit box 12 associated with a text file 14. The text file 14 contains stored text 16 (either entered by a user through the text-edit box 12 or loaded from a file or the like) displayed in the text-edit box 12 as displayed text 18. The stored text 16 may be, for example, a template for preparing patient visit notes or the like, a “copy forward” copy of previously prepared patient visit notes.

As will be understood to those of ordinary skill in the art, the text-edit box 12 includes capabilities for standard editing of the stored text 16 by manipulation of the displayed text 18 to insert text, delete text and reformat text, for example.

In the present invention, the stored text 16 includes alphanumeric ASCII characters of standard text 17, specially designated linking characters 20 (represented as the “@” symbol), and specially designated marking characters 50 (represented as the “*” symbol), the latter to be described further below. More generally, the linking characters 20 and the marking characters 50 need not be printing characters and may be character strings so long as they are uniquely distinguishable from normal text. The linking characters 20 and marking characters 50 inform the smart text object 11 that associated link text 22 and expanded text 46 are “protected” to be treated differently from standard text 17 and, in particular, that the link text 22 and expanded text are not edited with normal editing commands.

The linking characters 20 and marking characters of the text file 14 may be mapped to arbitrary characters of the displayed text 18 and in the preferred embodiment, the linking characters 20 are displayed as “{ } ” symbols in displayed text 18 embracing the link text 22, and the marking characters 50 are displayed as a highlighting expanded text 46. Usefully, the linking characters 20 and marking characters 50 are displayed in a form that is readily distinguishable from standard text so as to inform the user that the link text 22 and expanded text 46 is treated as protected text by the smart text object 11. Clearly any method of distinguishing this protected text may be used. The linking characters 20 may be the same in both the text-edit box 12 and the text file 14 so long as they can be distinguished from regular text. Thus link text 22 may be preceded by a “.” linking character 20′ and followed by a space linking character 20′ in both the text file 14 and the text-edit box 12, as this unusual use of these characters identifies them as linking characters 20 and not standard text 17.

As will be explained in more detail below, the smart text object 11 allows for the insertion of linking characters 20 in the text file 14 associated with expanded text 46 held in an external source. On an automatic basis, or by command from the user, the linking characters 20 and the link text 22 is replaced with the expanded text 46 from the external source to create expanded text file 14′. In this expanded text file 14′, the expanded text 46 is marked by marking characters 50.

Generally, the invention contemplates three categories of linking characters 20 and link text 22, (1) “SmartText” that when invoked causes the smart text object 11 to replace the link characters 20 and link text 22 with expanded text obtained from the external source, (2) SmartList that when invoked causes the smart text object 11 to provide a pick list of options each providing for replacing the link characters 20 and link text 22 with different expanded text obtained from the external source, and (3) “SmartSections” that provide a list of pre-defined section headers and footers that serve to delineate sections of the text, the link text 22, for later machine searching or cataloging.

The smart text object 11 may allow for the saving or loading of both the text file 14 and expanded text file 14′. In the former case, the ability to save and load a text file 14 with link text 22 and linking characters 20 allows the creation of templates having pre-prepared standard text 17 and linking characters 20, but possibly requiring selection among different options for the insertion of expanded text 46. In the latter case, the saving and loading of expanded text files 14′ allows reuse (“copy forward”) of previously prepared patient notes in which the expanded text 46 has been selected and inserted, but which may now be changed to be suitable for a current patient visit with minor editing.

The smart text object 11, under control of a user communicating through a keyboard and/or cursor control device, may not only edit the standard text 17 but may insert and modify link text 22 and linking character 20 using special auxiliary editing routines. This latter process of inserting and/or modifying link text 22 and linking character 20 requires not only the insertion of link text 22 and linking character 20 into the text file 14, but also the establishment of a connection between the link text 22 and expanded text 46 from an external source.

In the preferred embodiment, the external source will typically be a specially prepared link database 32 and/or the electronic medical record 36, but it can be any electronic data repository including searchable text files, web pages and the like. The electronic medical record 36 is a database holding patient medical data and accessible by a variety of healthcare professionals who collect or use such medical data. As such, the electronic medical record 36 is constantly changing outside of the context of the documentation program 10. In this sense, the expanded text 46 will be dynamic.

The link database 32, on the other hand, is typically only changed within the context of the documentation program 10 and will hold static phrases of expanded text 46. The link database 32 will also hold pick list information 47, created by the user through the smart text object 11, to facilitate the selection of expanded text 46. Skeleton phrases of expanded text 46 in the link database 32 allow the expanded text 46 to be obtained, both from the link database 32 and the electronic medical record 36, by placing link text 22 in skeleton static phrases in the link database 32 where the embedded link text 22 points to dynamic text from the electronic medical record 36 as indicated by arrow 49.

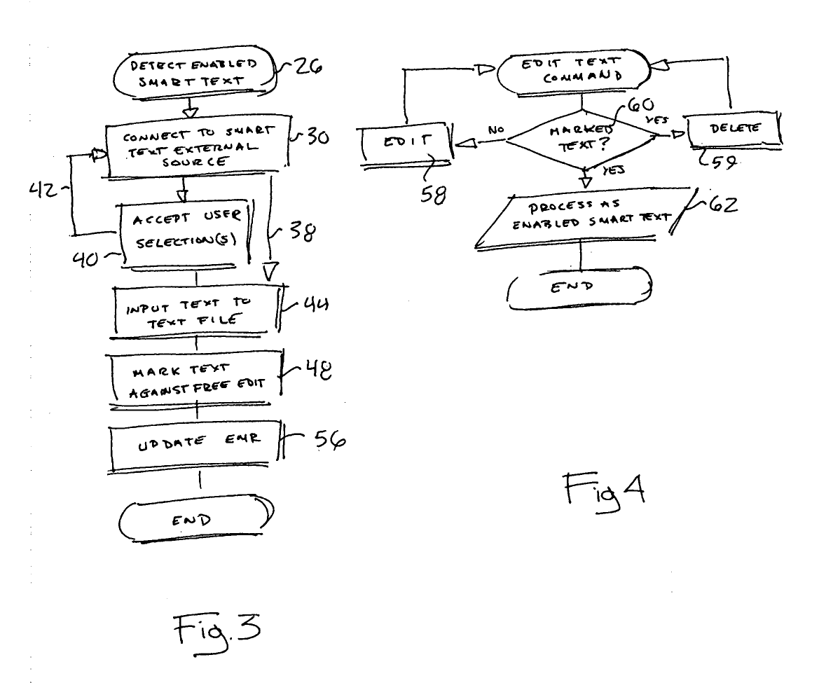

Referring now to FIGS. 1 and 3, a typical use of the smart text object 11 involves the loading of a template consisting of a previously prepared text file 14 having standard text 17 as well as link text 22. As indicated by arrow 24, the smart text object 11 translates the text file 14 to text displayed in the text-edit box 12 marking the link text 22 by curly braces being the manifestation of the linking characters 20 of the text file 14 in the text-edit box 12.

The smart text object 11 communicates with a keyboard, mouse or other user input device of a computer (not shown) to allow unrestrained editing of the standard text 17 and to detect any “enabled” smart text 25 as indicated by process block 26. Enabled smart text 25 is smart text 25 that is ready to be expanded because no further argument information is required for the expansion. Generally link text 22 that is a simple abbreviation to be expanded (“SmartText”) is immediately enabled for expansion. In other cases, as will be described below, where the user must provide additional argument information before the text expansion (“SmartLists”), enabling is obtained by selection of the link text 22 and the pressing of a special key (for example, the F2 key on the keyboard) and the supply of additional information (usually through pick lists) by the user. “SmartSections” are generally not expanded but exist as protected text in a manner similar to expanded text from “SmartText” and “SmartLists”.

As indicated by arrow 28 in FIG. 1 and process block 30 of FIG. 3, detection of enabled smart text 25 causes the smart text object 11 to obtain expanded text 46 from the link database 32 or electronic medical record 36. In this process, the link database 32 is typically presented with data from the context information 33 of the smart text object 11 together with the link text 22 and user-supplied additional arguments so that it may identify the appropriate expanded text 46, the latter which may be indexed in database fashion by these arguments and inserted directly into the text file 14, replacing the link text 22 as indicated by arrow 38 in FIG. 1 and process block 44 of FIG. 3.

Thus, for example, if the application documentation program 10 is working on patient notes for a particular patient, the context information 33 will include a patient identification number and the link text 22 will provide the remaining argument, for example “id”. In this case, the link database 32 selects expanded text 46 of a skeleton sentence (e.g. “@patient name@ is a @age@ year old @gender@”) containing further link text 22 that cause the sentence to be populated with the patient's name, age, and gender from the electronic medical record 36.

In a simpler case, the link text 22 may be an abbreviation that maps directly to static text held in the link database 32 without further reference to the electronic medical record 36, as referred to in U.S. Pat. No. 5,781,891 cited above and hereby incorporated by reference, or that maps to a single element of data of the electronic medical record 36.

The above examples provide smart text 25 that may be instantly expanded upon opening of the text file 14. The present invention also contemplates expanded text that accommodates additional user input, typically the selection from among different expanded text 46. This approach not only speeds text entry but also provides cues of possible text entries, for example, a list of diagnoses.

For link text 22 that require further user input before expansion, the link database 32, as indicated by arrow 34, provides a pick list 37 to the smart text object 11 in lieu of replacement text to be inserted directly into the text file 14. No special linking characters 20 are required, rather the link database 32 may identify the need for additional user input when it receives the link text 22 by the result of a database query that reveals the presence, for example, of pick list information 47. In this case, a pick list 37 is generated from the pick list information 47 and sent to the smart text object 11 to be displayed to the user in the text-edit box 12 as indicated by arrow 34.

Pick lists 37 may be nested so that selection of one pick list item 39 invokes a second pick list 37 (per arrow 42 of FIG. 3) as will be understood to those of ordinary skill in the art, to provide a hierarchical menu. Pick lists may carry conditions of only one element of the list being selected or may allow for multiple selections from each list per rules contained in the link database 32. The particular pick list may be modified by the context information 33, for example, to provide choices relevant solely to male or female patients as required.

Ultimately, the user selections provide sufficient arguments to the link database 32 so that particular expanded text 46 may be input into the text file 14 as indicated by process block 44. Thus, as shown, the phrase “The patient has @pain@” (where “@” are the linking characters 20 and “pain” is the link text 22) in text file 14 may be completed through this process with automatically expanded text 46 “severe pain” in expanded text file 14″.

At process block 48, this expanded text 46 is identified with marking characters 50 (“*”) inserted by the smart text object 11. At the same time, as indicated by arrow 38, machine interpretable data representing the substance of the expanded text 46 may be inserted into a database such as the electronic medical record 36 as indicated by arrow 54 of FIG. 1 and process block 56 of FIG. 3. Alternatively or in addition, the changes to the expanded text may be logged to create a history of such changes.

The data entered into the electronic medical record 36 may be standardized, for example, by diagnosis code or other standard machine-interpretable code and does not require direct machine interpretation of the expanded text 46 or other text of the patient note inserted into the text file 14.

The smart text object 11 provides a “copy forward” command which, using the context information 33, loads a previously expanded text file 14′ together with the marking characters 50 into the documentation program 10.

Referring now to FIGS. 1 and 4, should the user attempt to edit standard text 17 as identified by decision block 60, such standard text 17 may be freely edited per process block 58.

On the other hand, if the user should try to edit expanded text 46 (“protected text” as identified by marking characters 50, then at decision block 60, the smart text object 11 identifies this as marked text and blocks that editing.

In a first embodiment, for simple expanded text 46 that require no user supplied arguments (for example, the expansion of simple abbreviations) no editing is allowed except for deletion of the expanded text 46 as indicated by process block 59. Generally no changes of this simple expanded text 46 will be required in the situation where a previous patient record for the same patient is being used as a model because no changes to this information will have occurred. Thus, if the user is attempting to replace or type over portions of the expanded text 46, this is blocked.

In a second embodiment, the marking characters 50 and the link text 22 are preserved (rather than overwritten) so that the expanded text 46 may be instantly recreated. The marking characters 50 signal the smart text object 11 to not display the link text 22 in the expanded text file 14′. This preservation of the link text 22 is useful, for example, when the expanded text refers to a dynamic quantity, (e.g., patient's weight) obtained from the electronic medical record 36. In this case, again, no editing of the expanded text 46 (except for its automatic updating) is allowed.

As determined by decision block 60, the smart text object 11 may establish that the expanded text 46 requires additional user input (e.g., from pick lists 37) by review of the retained link text 22 forwarded to the link database 32 and as indicated by decision block 60. In this case, as indicated by process block 62, the smart text object 11 proceeds to process block 30, and using the embedded link text 22, executes the steps given in detail by process blocks 26 through 56 described above. In this case, the previous expanded text 46 is replaced by new expanded text 46 based on new user input through the newly invoked pick lists 37.

By recreating the expansion process, rather than allowing direct editing of the expanded text 46, it can be ensured that the machine-interpretable data sent to the electronic medical record 36 is properly synchronized with changes in the text file 14.

Referring now to FIG. 2, a text file 14 may be used as a template that may be transferred to different copies of the documentation program 10, 10′ running, for example, at different institutions. The transferred template has all the properties of the original document including protection of marked text and re-expansion capabilities. This allows templates formed of the text files 14 to be exchanged and potentially for a market to develop of templates prepared for particular situations. For this purpose, the smart text object 11 may allow an exporting of the text file 14 as indicated by arrow 55. In this case, the link database 32 is appended to the text file so that they may be transmitted together. At the destination documentation program 10′, the text file 14 is loaded and the contents of the link database 32 are installed as required under the control of the smart text object 11′. In use, the text file 14 takes it context information 33 (not shown) from the smart text object 11′ of the destination documentation program 10′, and may use the electronic medical record 36′ of the destination documentation program 10′ but the original link database 32 whose hierarchies and phrases will typically have been customized to the text file 14 by the user.

It is specifically intended that the present invention not be limited to the embodiments and illustrations contained herein, but include modified forms of those embodiments including portions of the embodiments and combinations of elements of different embodiments as come within the scope of the following claims.

We claim:

1. A clinical documentation tool comprising a program executable on a computer to:
(a) display to a user a text-editing box allowing entry and editing of text of a text field of the text-editing box by the user in which text may be replaced with arbitrary different text;
(b) accept links into the text field that allow selection among different text to be imported from an outside source into the text field by user selection commands to create expanded text;
(c) upon receiving a first user selection command, importing selected text from the outside source into the text field; and
(d) marking expanded text to allow later importation of different text from the outside source by a second user selection command.

2. The clinical documentation tool of claim 1 wherein the program allows copying of the marked expanded text for use as a starting point for an independent text field.

3. The clinical documentation tool of claim 1 wherein the expanded text is marked with characters embedded in the text field.

4. The clinical documentation tool of claim 3 wherein the characters cause a visible modification to the expanded text.

5. The clinical documentation tool of claim 1 wherein the importation of text is from an electronic data repository.

6. The clinical documentation tool of claim 5 wherein the electronic data repository is an electronic medical record.

7. The clinical documentation tool of claim 1 wherein the selection command includes the step of selecting a text string associated with a link.

8. The clinical documentation tool of claim 1 wherein, upon receiving the selection command, the program presents a menu from which text may be selected.

9. The clinical documentation tool of claim 8 wherein the menu allows simultaneous selection of multiple text items to be imported in sequence.

10. The clinical documentation tool of claim 8 wherein the menu allows only one text item selection to be imported.

11. The clinical documentation tool of claim 8 wherein the menu selectively allows selection of choices based upon previous choices.

12. The clinical documentation tool of claim 8 wherein the menu selectively allows selection of choices based upon a context in which the clinical documentation tool is operating.

13. The clinical documentation tool of claim 1 wherein the program allows deletion of the expanded text.

14. The clinical documentation tool of claim 1 wherein the program restricts the editing of the expanded text.

15. The clinical documentation tool of claim 1 wherein a record of changes to expanded text is maintained.

16. A clinical documentation comprising a program executable on a computer to:
(a) display to a user a text-editing box allowing entry and editing of text of a text field of the text-editing box by the user in which text may be replaced with arbitrary different text;
(b) accept links into the text field that allow importation of text from an outside source into the text field by user linking commands;
(c) upon receiving a user linking command, importing text from the outside source into the text field; and
(d) marking expanded text against replacement with arbitrary different text; and
(e) updating a data repository upon each importation to provide a machine readable record of the expanded text.

17. The clinical documentation tool of claim 16 wherein the data repository is a patient electronic medical record.

18. The clinical documentation tool of claim 16 wherein the expanded text is marked with characters embedded in the text field.

19. The clinical documentation tool of claim 16 wherein the characters cause a visible modification of the expanded text.

20. The clinical documentation tool of claim 16 wherein the importation of text is from a data repository.

21. The clinical documentation tool of claim 16 wherein the data repository from which text is imported is a patient electronic medical record.

22. The clinical documentation tool of claim 16 wherein the linking command includes the step of selecting a text string associated with the links.

23. The clinical documentation tool of claim 16 wherein upon receiving the linking command, the program presents a menu from which different text may be selected.

24. The clinical documentation tool of claim 23 wherein the menu allows simultaneous selection of multiple text items from among more than two text items.

25. The clinical documentation tool of claim 23 wherein the menu allows only one text item selection to be imported.

26. The clinical documentation tool of claim 23 wherein the menu selectively allows selection of choices based upon previous choices.

27. The clinical documentation tool of claim 23 wherein the menu selectively allows selection of choices based upon a context in which the clinical documentation tool is operating

28. The clinical documentation tool of claim 16 wherein the expanded text is visibly modified.

29. A method of providing machine readable medical reports comprising the steps of:
(a) providing text-editing boxes in a first and second program allowing entry and editing of text of a text field of the text-editing boxes in which text may be replaced with arbitrary different text;
(b) accepting links into the text field that allow selection among different text to be imported from an outside source into the text fields by user selection commands to create a template;
(c) providing for a transfer of the template to a second text box of the second program;
(d) upon receiving a first user selection command in the second program, importing selected text from the outside source into the text field of the transferred template; and
(e) marking expanded text to allow later selection of different text from the outside source by a second user selection command.

30. The method of claim 29 wherein the step of providing for the transfer of the text filed also provides for a transfer of at least a portion of the outside source.

31. The method of claim 30 wherein the portion of the outside source includes a tree structure for selecting among text to be imported and the text to be imported.

32. The method of claim 29 wherein the program restricts the editing of the expanded text.
